(19) United States
(12) Patent Application Publication
(10) Pub. No.: US 2022/0012608 A1
(43) Pub. Date: Jan. 13, 2022

(54) PRIORITIZING ALERTS IN INFORMATION TECHNOLOGY SERVICE MANAGEMENT SYSTEMS

(71) Applicant: ServiceNow, Inc., Santa Clara, CA (US)

(72) Inventor: Yaron Lehmann, Tel Aviv (IL)

(21) Appl. No.: 16/926,500

(22) Filed: Jul. 10, 2020

(51) Int. Cl. G06N 5/04; G06F 11/30; G06F 11/34; G06N 20/00

(52) U.S. Cl. CPC G06N 5/04; G06F 11/3006; G06N 20/00; G06F 11/3082; G06F 11/3495; G06F 11/3055

(57) ABSTRACT

A plurality of correlations is determined including by applying a machine learning model to a first plurality of features extracted from a plurality of information technology and operations management alerts and information technology service management reporting data. Each correlation of the plurality of correlations is between a corresponding one of the plurality of information technology and operations management alerts and at least one corresponding portion of the information technology service management reporting data. The information technology service management reporting data includes at least one urgency indicator. A prioritized list of information technology and operations management alerts is generated based at least in part on the determined plurality of correlations and the at least one urgency indicator. The prioritized list of information technology and operations management alerts is organized based at least in part on relative priorities of the alerts.

### BACKGROUND OF THE INVENTION

Existing information technology service management (ITSM) systems utilize alerts generated by information technology and operations management (ITOM) monitoring systems when potential problems are detected. Due to the rapid increase in the amount of communication among network components, the number of ITOM alerts that may be generated during the course of normal operations can be impractical to address properly. Specifically, a common organization may have tens of thousands of alerts generated daily, a number which is practically impossible to address manually by human operators. To this end, solutions for automatically addressing alerts have been developed.

An ITOM alert is useful for determining that a problem has likely occurred, but each alert does not provide any information about the root of the problem (i.e., the event or misconfiguration that triggered the alert). Additionally, the same event may trigger multiple alerts. These alerts may be similar such that each additional alert does not provide significant new information. Further, some alerts may be triggered by unusual activity that is not otherwise indicative of an underlying issue that needs to be fixed. As a result, there may be excessive numbers of low information alerts.

### BRIEF DESCRIPTION OF THE DRAWINGS

Various embodiments of the invention are disclosed in the following detailed description and the accompanying drawings.

FIG. 1 is a network diagram utilized to describe various disclosed embodiments.

FIG. 2 is a flowchart illustrating a method for prioritizing information technology and operations management (ITOM) alerts according to an embodiment.

FIG. 3 is a flowchart illustrating a method for data preparation according to an embodiment.

FIGS. 4A-B are example flow diagrams illustrating machine learning to correlate ITSM alerts with tickets and with resolution data, respectively.

FIG. 5 is a schematic diagram of an alert prioritizer according to an embodiment.

FIG. 6 is a flow diagram illustrating an embodiment for alert and ticket creation.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Some embodiments of the present disclosure relates generally to efficiently addressing alerts in information technology service management (ITSM) systems, and more specifically to prioritizing information technology and management (ITOM) alerts based on data from ITSM systems.

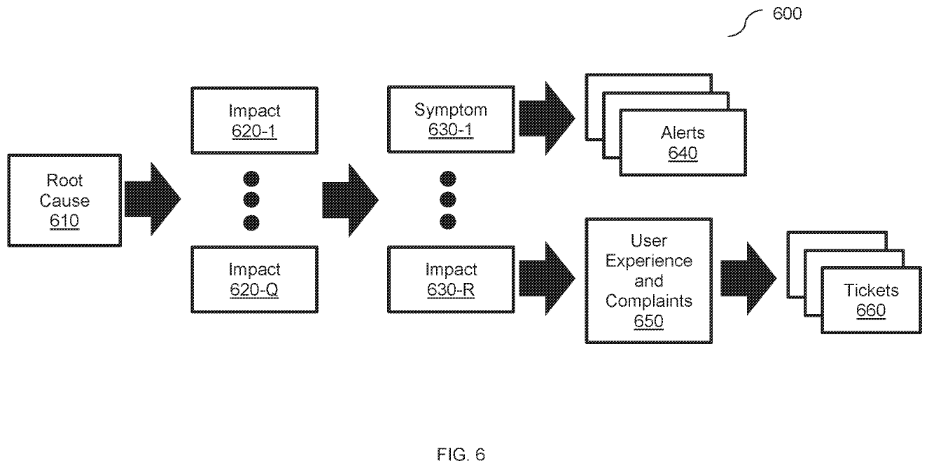

FIG. 6 is an example flow diagram 600 illustrating alert and ticket creation. A root cause 610 leads to impacts 620-1 through 620-Q (wherein Q is an integer having a value of 1 or greater), any of which (or any combination of which) results in symptoms 630-1 through 630-R (where R is an integer having a value of 1 or greater). The symptoms 630 manifest within one or more systems. Reactions to the symptoms 630 typically include alerts 640 being generated by ITOM monitoring systems. At the same time, the symptoms 630 affects user experiences, thereby resulting in user experiences and complaints 650. In response, affected users submit their complaints via ITSM systems, thereby causing tickets 660 to be generated. Thus, the same root cause ultimately results in both detection of issues by traditional monitoring systems as well as reporting of issues within ITSM systems.

The alerts may be analyzed in order to suppress noise. This may add contextual information based on aggregated alerts that provide situational awareness of the alerts. For example, the rate of webserver error responses indicated in alerts is tracked and reported when there is an increase in the rate. Additional and improved solutions for further prioritizing ITOM alerts and/or suppressing noise among ITSM alerts would be desirable. It would therefore be advantageous to provide a solution that would overcome these challenges.

Certain embodiments disclosed herein include a method for prioritizing information technology and operations management (ITOM) alerts based on data from information technology service management (ITSM) systems. The method comprises: determining a plurality of correlations including by applying a machine learning model to a first plurality of features extracted from a plurality of ITOM alerts and ITSM reporting data, wherein each correlation of the plurality of correlations is between a corresponding one of the plurality of ITOM alerts and at least one corresponding portion of the ITSM reporting data, wherein the ITSM reporting data includes at least one urgency indicator; and generating a prioritized list of ITOM alerts based at least in part on the determined plurality of correlations and the at least one urgency indicator, wherein the prioritized list of ITOM alerts is organized based at least in part on relative priorities of the ITOM alerts.

Certain embodiments disclosed herein also include a non-transitory computer readable medium having stored thereon causing a processing circuitry to execute a process, the process comprising: determining a plurality of correlations including by applying a machine learning model to a first plurality of features extracted from a plurality of ITOM alerts and ITSM reporting data, wherein each correlation of the plurality of correlations is between a corresponding one of the plurality of ITOM alerts and at least one corresponding portion of the ITSM reporting data, wherein the ITSM reporting data includes at least one urgency indicator; and generating a prioritized list of ITOM alerts based at least in part on the determined plurality of correlations and the at least one urgency indicator, wherein the prioritized list of ITOM alerts is organized based at least in part on relative priorities of the ITOM alerts.

Certain embodiments disclosed herein also include a system for prioritizing information technology and operations management (ITOM) alerts based on data from information technology service management (ITSM) systems. The system comprises: one or more processors configured to: determine a plurality of correlations including by applying a machine learning model to a first plurality of features extracted from a plurality of ITOM alerts and ITSM reporting data, wherein each correlation of the plurality of correlations is between a corresponding one of the plurality of ITOM alerts and at least one corresponding portion of the ITSM reporting data, wherein the ITSM reporting data includes at least one urgency indicator; and generate a prioritized list of ITOM alerts based at least in part on the determined plurality of correlations and the at least one urgency indicator, wherein the prioritized list of ITOM alerts is organized based at least in part on relative priorities of the ITOM alerts; and a memory coupled to at least one of the one or more processors and configured to provide the at least one of the one or more processors with instructions.

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for prioritizing information technology and operations management (ITOM) alerts in information technology service management (ITSM) systems. The disclosed embodiments provide techniques for correlating ITSM activities with ITOM alerts and for prioritizing threats based on these correlations. The prioritization of threats may include removing redundant or otherwise low information ITOM alerts, thereby reducing noise and allowing for more efficient responses to threats.

The disclosed embodiments also allow for enriching ITOM alerts with ITSM information that may be relevant to addressing the ITOM alert. Specifically, since the disclosed embodiments provide correlations between ITSM activities and ITOM alerts, information of correlated ITSM activities may be used to enrich the ITOM alerts. The disclosed embodiments may be implemented into existing ITSM environments without impacting workflows within the environment.

In an embodiment, ITSM activities are correlated with ITOM alerts (hereinafter alerts) in order to prioritize the alerts. More specifically, portions of ITSM reporting data are correlated to alerts, and a weighted causality between each portion of ITSM reporting data and correlated alert is determined. Based on the weighted causalities, the alerts are prioritized. The prioritization may result in, for example, an ordered list of prioritized alerts (i.e., ordered from most to least likely to be causally linked). The prioritization may further include removing alerts having weighted causalities below a threshold so as to suppress noise by removing irrelevant alerts.

In a further embodiment, the weighted causalities are determined using a two-stage machine learning process, with each stage including applying a machine learning model. Features are extracted from the results of the first stage and input to the machine learning model of the second stage. The first stage machine learning model uses inputs including alerts and ITSM activities in the form of tickets, resolution information, or both. The results of the first stage include pairs of alerts and corresponding correlated ITSM activities. The second stage machine learning model uses inputs including the correlated pairs and one or more features indicative of degree of correlation between alerts and ITSM activities.

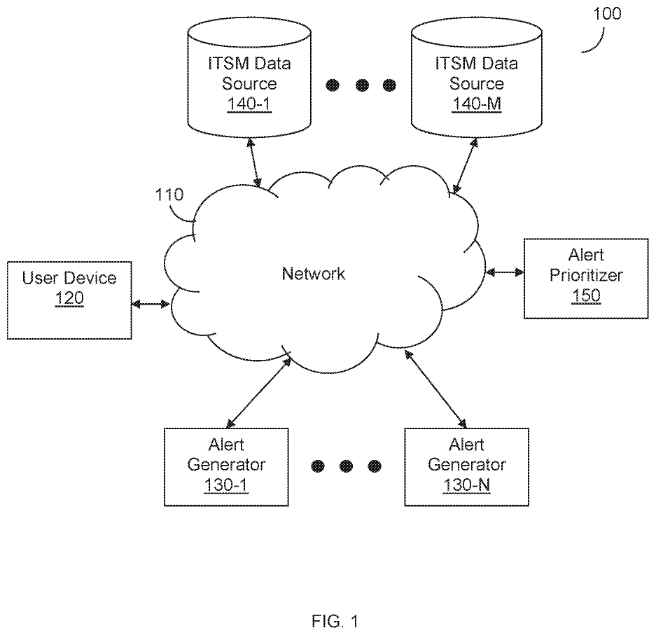

FIG. 1 shows an example network diagram 100 utilized to describe the various disclosed embodiments. In the example network diagram 100, a user device 120, alert generators 130-1 through 130-N (hereinafter referred to individually as an alert generator 130 and collectively as alert generators 130) Information Technology Management System (ITSM) data sources 140-1 through 140-M (hereinafter referred to individually as an ITSM data source 140 and collectively as ITSM data sources 140), and an alert prioritizer 150 are communicatively connected via a network 110.

The network 110 may be, but is not limited to, a wireless, cellular or wired network, a local area network (LAN), a wide area network (WAN), a metro area network (MAN), the Internet, the worldwide web (WWW), similar networks, and any combination thereof.

The user device (UD) 120 may be, but is not limited to, a personal computer, a laptop, a tablet computer, a smartphone, a wearable computing device, or any other device capable of receiving and displaying prioritized alerts.

The alert generators 130 are configured to generate alerts indicative of ITOM issues. The alerts include data such as, but not limited to, types of issues, time of alert generation, issue identifiers (for known issues), affected entities (e.g., devices or systems exhibiting symptoms), combinations thereof, and the like. The alert generators 130 may include, but are not limited to, ITSM monitoring systems, systems deployed in a network of an organization (i.e., systems monitored for ITSM systems such as personal computers, servers, etc.), and the like. The alerts may be generated in response to events occurring within environments monitored by the alert generators 130.

The ITSM data sources 140 include sources of ITSM activity data. The ITSM reporting data includes tickets, resolution data, or both. To this end, the ITSM data sources 140 may include, but are not limited to, ITSM systems (e.g., ServiceNow®, BMC Remedy, etc.), ticket repositories, or both.

The tickets may be, for example, created based on user submissions reporting issues (e.g., based on emails from users, phone calls with users, user inputs provided via web portals, etc.). Each ticket includes at least a textual description of an issue. The issue may be indicative of an event (e.g., an event which caused an alert to be generated by one of the alert generators 150).

The resolution data includes data related to resolution of an issue by an IT professional. Such resolution data may include, but is not limited to, identifications of root causes of threats, textual descriptions of issues, textual descriptions of affected entities, textual descriptions of steps taken to resolve issues (i.e., steps taken to fix problems), severity values representing relative severities of issues, and the like.

In some implementations, tickets may be bundled and tied to resolution data by the alert prioritizer 150 as described herein. The bundled tickets and resolution data may be utilized as inputs to a machine learning model trained to identify correlations between ITSM activities and ITSM alerts.

The alert prioritizer 150 is configured to prioritize alerts as described herein. As noted above, it has been identified that alerts are frequently the results of the same root causes as tickets or resolution data. Additionally, tickets and resolution data include additional information/indicator that may be relevant to identifying the root cause, determining how urgent the problem is, or both. More specifically, tickets and resolution data include information related to user impact that is not reflected in alerts. Therefore, ITSM reporting data may be correlated to alerts and used to more accurately prioritize alerts by automated systems than by prioritizing alerts based solely on the contents of the alerts.

As a non-limiting example for the prioritizing benefits of correlating alerts to ITSM reporting data, a root cause may be a failure that interrupts communications between a web server and its database. As a result, at least some users trying to log in to the web server fail to do so. These users who fail to log in report the problem to an IT professional and tickets are created for the reported problems. At the same time, a symptom on another web server (e.g., a fall in pace of communication) triggers an alert. The IT professional resolves the problem or otherwise sees that the problem is resolved, and may create resolution data indicating information. By identifying the relationship between the alert and the tickets, future alerts may be more accurately prioritized since the tickets

The alert prioritizer 150 is configured to receive or retrieve alerts and ITSM reporting data from the alert generators 130 and the ITSM data sources 140, respectively, and to determine correlations between alerts and sets of ITSM reporting data. The alert prioritizer 150 may be further configured to enrich the alerts using the ITSM reporting data. The alert prioritizer 150 may also be configured to generate and send notifications regarding alert priorities to, for example, the user device 120.

It should be noted that FIG. 1 illustrates alert generators 130 merely for example purposes, and that other sources of alerts (e.g., databases storing alerts) may be utilized in addition to or instead of the alert generators 130 without departing from the scope of the disclosed embodiments.

It should also be noted that the deployment of the alert prioritizer 150 shown in FIG. 1 is merely an example, and that other deployments are possible. For example, the alert prioritizer 150 may be a physical system or a virtual machine, and may be deployed in-cloud or on-premises of an organization.

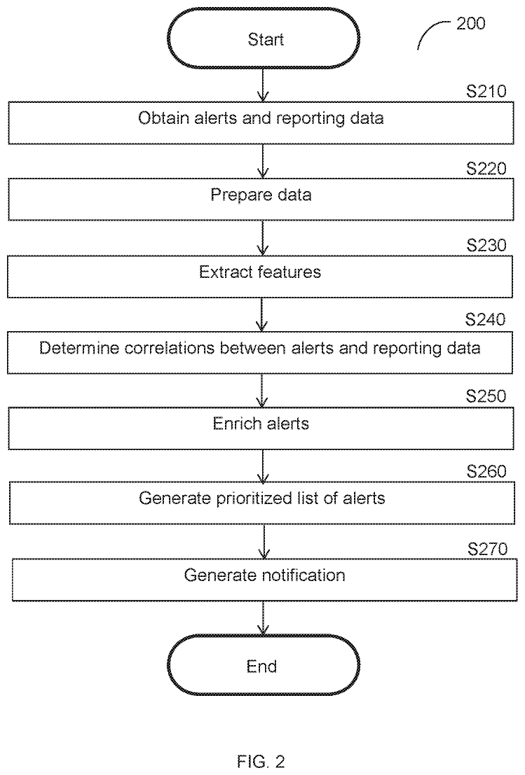

FIG. 2 is an example flowchart 200 illustrating a method for prioritizing ITOM alerts according to an embodiment. In an embodiment, the method is performed by the alert prioritizer 150.

At S210, alerts and ITSM reporting data are obtained. In an example implementation, the alerts are received from alert generators (e.g., the alert generators 130, FIG. 1), and the ITSM reporting data includes tickets, resolution data, or both, retrieved from ITSM data sources (e.g., the ITSM data sources 140, FIG. 1). The ITSM reporting data includes textual descriptions of problems experienced by users, of resolutions to such problems, or combinations thereof.

At optional S220, the data obtained at S210 is prepared. In an embodiment, S220 includes cleaning text in the obtained data, bundling tickets, tying tickets to resolution data, or a combination thereof.

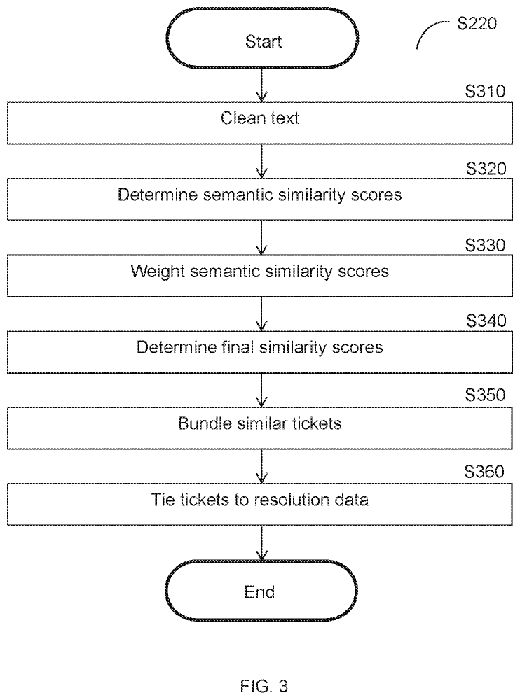

FIG. 3 is an example flowchart S220 illustrating a method for data preparation according to an embodiment.

At S310, text in the data is cleaned. The cleaning may include, but is not limited to, stemming, removal of extra whitespace, correcting misspellings, stop-word removal, converting synonyms (e.g., converting “X minutes,” “forever,” or “long time” to simply “time”). The cleaning may be based on a predetermined dictionary, thesaurus, or both. The cleaning may result in textual descriptions of problems that only include information likely to uniquely identify the problems among a larger set of problems. To this end, the cleaning removes words which are commonly used for sentence construction or otherwise do not provide information about problems.

At S320, semantic similarity scores are determined for the tickets. Each semantic similarity score indicates a degree of similarity between two of the tickets and may therefore be used for bundling tickets based on similarity. In an embodiment, S310 includes deriving a semantic similarity score for each pair of tickets using a machine learning model trained based on features derived from historical collections of text.

More specifically, in an embodiment, S320 includes applying a machine learning model to features extracted from the tickets. The extracted features include portions of text describing problems and may include, but are not limited to, names or other identifiers of affected entities, adjectives describing effects of the symptom (e.g., effects on system performance such as “slow”), verbs describing activities that may be affected (e.g., “load”), combinations thereof, and the like. The machine learning model is trained using features extracted from historical tickets.

As a non-limiting example, the following textual descriptions of symptoms may represent the same symptom and may be identified by common features including name of the system affected, use of the same adjective regarding effects on system performance, and conceptual relations between the adjectives and verbs representing system activities. The following problem descriptions represent the same symptom:
1) “The system is loading very slowly and you can't purchase anything”
2) “System A is very slow for all team members”
3) “It takes system A between 5-10 minutes to load”
4) “System A loads forever”

These problem descriptions may be cleaned as discussed above with respect to S310, resulting in the following textual descriptions from which features are extracted.
1) “system load slow can't purchase”
2) “System A slow team members”
3) “system A time to load”
4) “System A loads time”

These tickets may be determined as semantically similar via the machine learning model on the basis of shared textual portions “system A,” “slow,” and [“load”+time term].

At S330, the semantic similarity scores may be weighted based on one or more other characteristics of the tickets such as, but not limited to, characteristics indicated in ticket metadata. Such characteristics may include, for example, time (i.e., tickets created close in time are more likely to be similar), system(s) affected, user(s) affected, and the like. To this end, in an embodiment, S330 includes determining a weight each semantic similarity score using predetermined rules with respect to ticket characteristics. The ticket metadata may be used to improve accuracy of the semantic similarity determination by providing contextual information further indicating whether similar text really represents the same problem. As a non-limiting example, identical portions of text occurring in tickets that were created a year apart may be weighted very low.

At S340, final similarity scores are determined based on the semantic similarity scores and the weights.

At S350, based on the final similarity scores, similar tickets are bundled. In an embodiment, each ticket is bundled with each other ticket having a shared final similarity score above a threshold (i.e., if a pair of tickets has a similarity score above a threshold, the tickets of the pair are bundled together).

It has been identified that an alert may be indicative of more than one possible root cause and, therefore, may relate to more than one type of problem that will affect and be reported by users. Thus, bundling tickets that may represent different problems or variations of the same problem allows for more accurately prioritizing alerts than tying each alert to a single ticket.

At S360, the bundled tickets are tied to resolution data. In an embodiment, tickets may be tied to resolution data based on the textual descriptions therein using a machine learning model trained like the machine learning model described with respect to S320 (i.e., using at least some of the same features extracted from textual descriptions). That is, common textual features such as names of affected entities, adjectives describing effects of symptoms, and verbs describing affected activities may be used to tie tickets to resolution data based on similarity scores.

It should be noted that FIG. 3 is described with respect to bundling tickets and tying bundled tickets to resolution data, but that some embodiments may prepare data without either bundling tickets or tying tickets to resolution data.

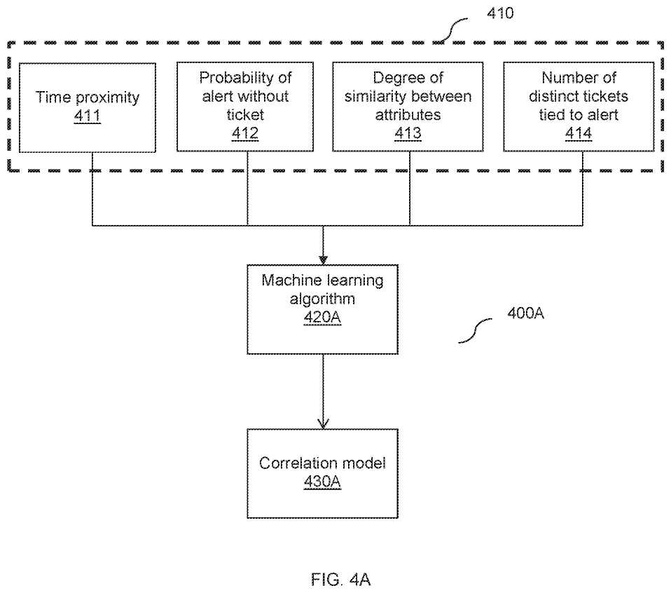

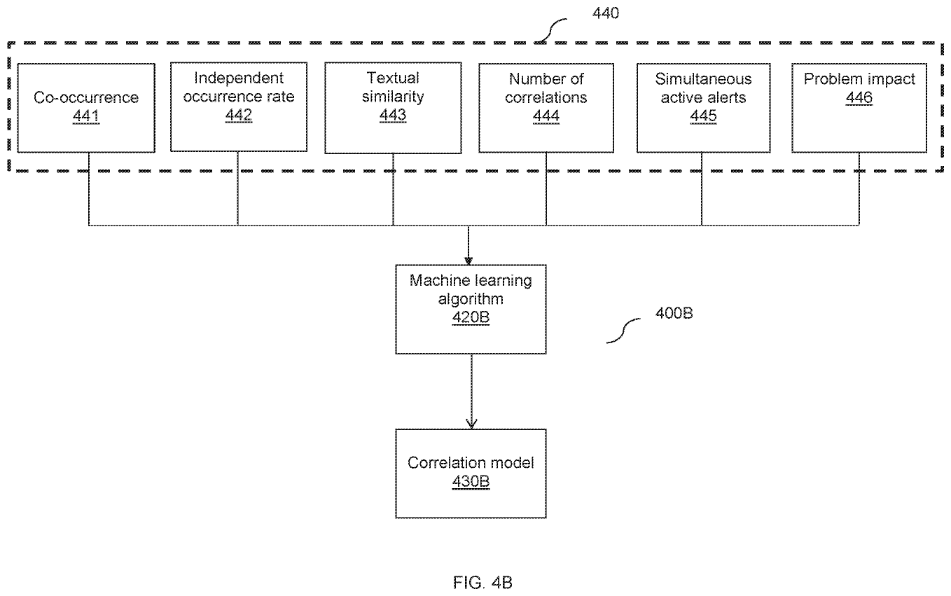

Returning to FIG. 2, at S230, features to be used for correlation are extracted. The features include, for example, ticket-related features, resolution-related features, or both. Example ticket-related and resolution-related features are described below with respect to FIGS. 4A-B. In an embodiment, at least some of the extracted features may be determined based on the alerts and the ITSM reporting data. For example, a number of co-occurrences may be determined as the number of times an alert occurred within a threshold time period of ITSM reporting data being created.

At S240, correlations are determined between the alerts and the ITSM reporting data. In an embodiment, S240 includes using the extracted features as inputs to a machine learning model trained to determine correlations between alerts and ITSM reporting data based on historical alerts and ITSM activities. The machine learning model is trained to output a degree of causality indicating the degree to which each alert is caused by each correlated portion of ITSM reporting data which, in turn, represents the likelihood that an alert and the correlated portion of ITSM reporting data are related. The correlations may be between an alert and a ticket, an alert and multiple tickets (e.g., a bundle of tickets), an alert and one or more tickets tied to resolution data, or an alert and resolution data.

FIGS. 4A-B are example flow diagrams illustrating training a machine learning model to determine correlations between tickets and alerts and between resolution data and alerts, respectively.

FIG. 4A shows training of a correlation model based on ticket-related features. In FIG. 4A, ticket-related features 410 are input to a machine learning algorithm 420A in order to train a correlation model 430A. A time proximity feature 411 indicates the amount of time between generation of alert and creation of a ticket. A probability of alert without ticket feature 412 indicates a probability that the alert occurs without a corresponding ticket following (e.g., within a predetermined period of time). A degree of similarity between attributes feature 413 indicates a degree of similarity between alert attributes (i.e., measurements included in an alert) and ticket attributes (e.g., user that reported the problem for which the ticket was created, affected entities mentioned in the problem description such as error codes, keywords in the textual descriptions, etc.), numbers of tickets, or both. A number of distinct tickets tied to alert feature 414 indicates a number of related tickets that are tied to the alert. The feature 414 may be determined based on, for example, a number of distinct tickets in a bundle of tickets correlated to the alert.

FIG. 4B shows training of a correlation model based on ticket-related features. In FIG. 4B, resolution data-related features 440 are input to a machine learning algorithm 420B in order to train a correlation model 430B. A co-occurrence feature 441 indicates a number of times a resolution and an alert occurred together (e.g., within a threshold period of time). An independent occurrence rate feature 442 indicates a number of times a resolution and an alert occurred separately (e.g., one occurs without the other occurring within a threshold period of time). A textual similarity feature 443 indicates a degree to which the textual descriptions in the resolution match the textual descriptions in the alert. A number of correlations for alert feature 444 indicates a number of resolutions that have been correlated to the alert. A number of simultaneous active alerts feature 445 indicates a number of other alerts that are active at any time during which the alert in question is active. A problem impact feature 446 indicates a degree of severity of a problem related to the resolution (e.g., a problem indicted in a textual description of the resolution). The problem impact feature 446 may be, for example, a numerical representation of a degree of severity (i.e., a problem having a high severity may be represented as 9 on a scale from 1 to 10).

It should be noted that FIGS. 4A-B show separate trainings of machine learning models for tickets and resolution data, respectively, but that machine learning models may be trained to determine correlations between alerts and combinations of tickets and resolution data without departing from the scope of the disclosure. To this end, in an example implementation, inputs from both FIGS. 4A and 4B may be provided to the same machine learning algorithm during training. Such an implementation may be used when, for example, tickets are tied to resolution data, or otherwise in order to improve accuracy of the machine learning model by using features related to both tickets and resolution data.

At optional S250, the alerts are enriched with data related to their respective correlated tickets. The enrichment data may include, but is not limited to, one or more portions of ITSM reporting data or pointers thereto, textual data from one or more tickets (e.g., from a representative ticket selected from among a bundle of tickets), degrees of severity of the correlated ITSM reporting data, statistics related to the relationship between the alert and the correlated tickets, and the like. As a non-limiting example, the enrichment data for an alert may include textual data indicating that “85% of the time when this alert occurs, it is followed by 10 or more tickets having severities indicating critical impact. Here are examples of recent tickets: LinkToTicket1, LinkToTicket2.”

At S260, a prioritized list of alerts is generated based on the determined correlations. The prioritized list of alerts includes alerts organized from highest priority to lowest priority and may include all of the alerts or a subset (e.g., the top 10 highest priority alerts). In an embodiment, the alerts may be organized based on relative urgencies indicated by the correlated portions of ITSM reporting data. The urgencies may be based on, for example, severity of problems represented by the ITSM reporting data, degree of impact on users, both, and the like.

At S270, a notification is generated based on the prioritized list of alerts. The notification may include, but is not limited to, the prioritized list of alerts or a portion thereof (e.g., a predetermined number of the top alerts in the priority).

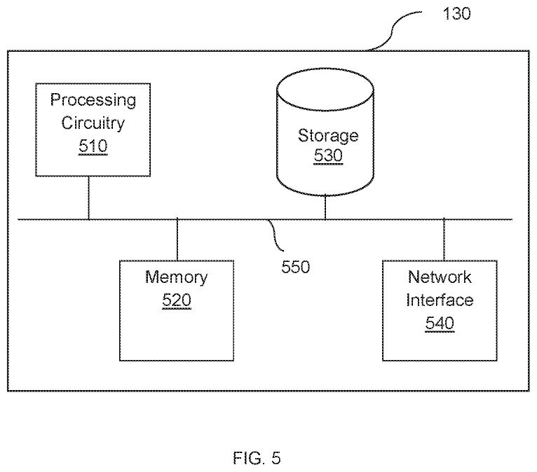

FIG. 5 is an example schematic diagram of an alert prioritizer 130 according to an embodiment. The alert prioritizer 130 includes a processing circuitry 510 coupled to a memory 520, a storage 530, and a network interface 540. In an embodiment, the components of the alert prioritizer 130 may be communicatively connected via a bus 550.

The processing circuitry 510 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 520 may be volatile (e.g., RAM, etc.), non-volatile (e.g., ROM, flash memory, etc.), or a combination thereof.

In one configuration, software for implementing one or more embodiments disclosed herein may be stored in the storage 530. In another configuration, the memory 520 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 510, cause the processing circuitry 510 to perform the various processes described herein.

The storage 530 may be magnetic storage, optical storage, and the like, and may be realized, for example, as flash memory or other memory technology, CD-ROM, Digital Versatile Disks (DVDs), or any other medium which can be used to store the desired information.

The network interface 540 allows the alert prioritizer 130 to communicate with the ITSM data sources 140 and the alert generators 150 for the purpose of, for example, obtaining alerts and ITSM reporting data. Further, the network interface 540 allows the alert prioritizer 130 to communicate with the user device 120 for the purpose of, for example, sending prioritized lists of alerts, notifications, and the like.

It should be understood that the embodiments described herein are not limited to the specific architecture illustrated in FIG. 5, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2As; 2Bs; 2Cs; 3As; A and B in combination; B and C in combination; A and C in combination; A, B, and C in combination; 2As and C in combination; A, 3Bs, and 2Cs in combination; and 2Bs and 3Cs in combination.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
determining a plurality of correlations including by applying a machine learning model to a first plurality of features extracted from a plurality of information technology and operations management alerts and information technology service management reporting data, wherein each correlation of the plurality of correlations is between a corresponding one of the plurality of information technology and operations management alerts and at least one corresponding portion of the information technology service management reporting data, wherein the information technology service management reporting data includes at least one urgency indicator; and
generating a prioritized list of information technology and operations management alerts based at least in part on the determined plurality of correlations and the at least one urgency indicator, wherein the prioritized list of information technology and operations management alerts is organized based at least in part on relative priorities of the information technology and operations management alerts.

2. The method of claim 1, wherein the prioritized list of information technology and operations management alerts is organized such that an alert in the information technology and operations management alerts that correlates to a higher urgency portion of the information technology service management reporting data is assigned a higher priority than another alert in the information technology and operations management alert that correlates to a lower urgency portion of the information technology service management reporting data.

3. The method of claim 2, wherein the at least one urgency indicator is based on at least one of: a severity of a corresponding information technology service management problem experienced by the user, and a degree of impact of the corresponding information technology service management problem on the user.

4. The method of claim 1, wherein the information technology service management reporting data includes a plurality of tickets, wherein each ticket includes a textual description of a corresponding information technology service management problem experienced by a user.

5. The method of claim 4, further comprising:
bundling the plurality of tickets into at least one bundle, wherein bundling the plurality of tickets further comprises determining a semantic similarity score for every two tickets of the plurality of tickets, wherein the semantic similarity scores are determined by applying a machine learning model to a third plurality of features extracted from the textual descriptions of the plurality of tickets.

6. The method of claim 5, wherein the semantic similarity scores are weighted based on metadata of the plurality of tickets, wherein the plurality of tickets is bundled based on the weighted similarity scores.

7. The method of claim 1, wherein the information technology service management reporting data includes resolution data associated with a plurality of resolutions to problems experienced by users, wherein at least a portion of the resolution data associated with one resolution of the resolutions includes a textual description of the one resolution.

8. The method of claim 1, further comprising:
enriching at least one first information technology and operations management alert of the plurality of information technology and operations management alerts based on the plurality of correlations, wherein the at least one first information technology and operations management alert is enriched with data from at least one correlated portion of the information technology service management reporting data.

9. The method of claim 1, wherein the machine learning model is trained based on a second plurality of features extracted from historical information technology and operations management alerts and historical information technology service management reporting data.

10. The method of claim 1, wherein each of the at least one urgency indicator is of a respective information technology service management problem experienced by a user.

11. A system, comprising:
one or more processors configured to:
determine a plurality of correlations including by applying a machine learning model to a first plurality of features extracted from a plurality of information technology and operations management alerts and information technology service management reporting data, wherein each correlation of the plurality of correlations is between a corresponding one of the plurality of information technology and operations management alerts and at least one corresponding portion of the information technology service management reporting data, wherein the information technology service management reporting data includes at least one urgency indicator; and
generate a prioritized list of information technology and operations management alerts based at least in part on the determined plurality of correlations and the at least one urgency indicator, wherein the prioritized list of information technology and operations management alerts is organized based at least in part on relative priorities of the information technology and operations management alerts; and
a memory coupled to at least one of the one or more processors and configured to provide the at least one of the one or more processors with instructions.

12. The system of claim 11, wherein the prioritized list of information technology and operations management alerts is organized such that an alert in the information technology and operations management alerts that correlates to a higher urgency portion of the information technology service management reporting data is assigned a higher priority than another alert in the information technology and operations management alert that correlates to a lower urgency portion of the information technology service management reporting data.

13. The system of claim 12, wherein the at least one urgency indicator is based on at least one of: a severity of a corresponding information technology service management problem experienced by the user, and a degree of impact of the corresponding information technology service management problem on the user.

14. The system of claim 11, wherein the information technology service management reporting data includes a plurality of tickets, wherein each ticket includes a textual description of a corresponding information technology service management problem experienced by a user.

15. The system of claim 14, wherein the one or more processors is further configured to:
bundle the plurality of tickets into at least one bundle, wherein bundling the plurality of tickets further comprises determining a semantic similarity score for every two tickets of the plurality of tickets, wherein the semantic similarity scores are determined by applying a machine learning model to a third plurality of features extracted from the textual descriptions of the plurality of tickets.

16. The system of claim 15, wherein the semantic similarity scores are weighted based on metadata of the plurality of tickets, wherein the plurality of tickets is bundled based on the weighted similarity scores.

17. The system of claim 11, wherein the information technology service management reporting data includes resolution data associated with a plurality of resolutions to problems experienced by users, wherein at least a portion of the resolution data associated with one resolution of the resolutions includes a textual description of the one resolution.

18. The system of claim 11, wherein the one or more processors is further configured to:
enrich at least one first information technology and operations management alert of the plurality of information technology and operations management alerts based on the plurality of correlations, wherein the at least one first information technology and operations management alert is enriched with data from at least one correlated portion of the information technology service management reporting data.

19. The system of claim 11, wherein the machine learning model has been trained based on a second plurality of features extracted from historical information technology and operations management alerts and historical information technology service management reporting data.

20. A computer program product embodied in a non-transitory computer readable medium and comprising computer instructions for:
determining a plurality of correlations including by applying a machine learning model to a first plurality of features extracted from a plurality of information technology and operations management alerts and information technology service management reporting data, wherein each correlation of the plurality of correlations is between a corresponding one of the plurality of information technology and operations management alerts and at least one corresponding portion of the information technology service management reporting data, wherein the information technology service management reporting data includes at least one urgency indicator; and
generating a prioritized list of information technology and operations management alerts based at least in part on the determined plurality of correlations and the at least one urgency indicator, wherein the prioritized list of information technology and operations management alerts is organized based at least in part on relative priorities of the information technology and operations management alerts.
